(19) United States
(12) Patent Application Publication
(10) Pub. No.: US 2010/0032509 A1
(43) Pub. Date: Feb. 11, 2010

(54) CABLE COLLECTING WINCH

(76) Inventors: Michele Cazzaro, Varese (IT); Andrea Merello, Genova (IT); Michiel Kruithof, Como (IT)

Correspondence Address: GODFREY & KAHN S.C., 780 NORTH WATER STREET, MILWAUKEE, WI, 53202, US

(21) Appl. No.: 12/500,734

(22) Filed: Jul. 10, 2009

(30) Foreign Application Priority Data
Aug. 7, 2008 (EP) 08425549.6

(51) Int. Cl. B66D 1/38; B65H 75/38; B65H 75/44

(52) U.S. Cl. 242/397.3

(57) ABSTRACT

A cable collecting winch (1) comprises a collecting drum (2) rotatably actuatable about a respective longitudinal axis (X-X) to wind/unwind a cable (100), and a cable guide device (3) kinematically connected with the collecting drum (2) and adapted to translate along a direction parallel to said longitudinal axis (X-X) upon rotation of the collecting drum (2) to guide the winding/unwinding of the cable (100). The collecting drum (2) and the cable guide device (3) form a nut and screw assembly wherein such components are respectively the screw and the nut of said nut and screw assembly.

### BACKGROUND

The present disclosure refers to a cable collecting winch which finds a preferred, although not exclusive, use in the nautical field.

Within the framework of the present description and of the subsequent claims, the term “cable” generally indicates any flexible elongated element adapted to withstand traction loads and to be wound around a reel, such as for example a wire, a string, a rope, a tape, a chain, etc. made of metal, textile, composite material or combination thereof.

In cable collecting winches, also known as “captive winches”, the cable is entirely collected and wound on the winch drum. These winches are usually motorised and they are capable of withstanding very high static and dynamic loads (even more than 20 tonnes). In the nautical field, for example, they are typically used for operating sheets on large sailboats.

Cable collecting winches essentially comprise a collecting drum rotatably actuatable about a respective longitudinal axis for winding/unwinding the cable and a cable guide device for guiding the winding/unwinding of the cable on the collecting drum.

The cable guide device ensures that the cable is distributed on the collecting drum uniformly and, if necessary—as, for example, in case of cables made of textile material—, without overlapping that might hinder a subsequent operation of the cable and/or damaging it. To this end, the cable guide device is kinematically connected with the collecting drum in such a way that a complete rotation of the collecting drum determines a displacement of the cable guide device along a direction parallel to the longitudinal axis of the collecting drum over a section of predetermined length, usually equal to the diameter of the cable to be wound/unwound.

Two different design solutions for providing kinematic connection between the collecting drum and the cable guide device are known, each influencing the features and performances of the cable collecting winch incorporating them.

In a first known design solution, the cable guide device comprises a nut and screw assembly, wherein the screw is arranged parallel to the collecting drum and kinematically connected therewith through a gear or chain/belt transmission system, and the nut supports a guide element. Through a suitable dimensioning of the gear ratio between the collecting drum and the screw of the nut and screw assembly it is possible to obtain the desired correspondence between the rotation of the collecting drum and the translation of the cable guide device.

Cable collecting winches of this kind are capable of withstanding high loads purely axial or having a major axial component. Therefore, configurations where the cable released by the winch is diverted in a direction parallel to the longitudinal axis of the collecting drum can be easily obtained. These configurations can be advantageous in some applications, because the release direction of the cable remains fixed and independent from the winding/unwinding point on the drum, and the required operating space around the winch is minimized. However, cable collecting winches of this type have a considerable overall dimension and they are more complex to be assembled and maintained, due to the high number of components required to provide the kinematic transmission between the collecting drum and the cable guide device. Furthermore, the high number of moveable parts exposes the winch to higher fault probability and negatively affects the transmission between the collecting drum and the cable guide device.

In a second known design solution, the collecting drum is provided with a helical groove at the outer surface thereof and the cable guide device comprises a slider element engaged with the helical groove and free to translate along a guide rail parallel to the longitudinal axis of the collecting drum. It is thus obtained that a complete rotation of the collecting drum directly determines a translation of the cable guide device corresponding to the pitch of the helical groove, without employing an intermediate transmission.

This second design solution overcomes the drawbacks of the previously described solution in terms of overall dimension, construction complexity, fault probability and transmission efficiency, but, due to the engagement between collecting drum and cable guide device through a slider, it is not suitable for withstanding high axial loads by itself. Therefore, in this case, a configuration where the cable is released in a axial direction or in a direction having a major axial component can be obtained only by providing further and suitable diverter elements separate from the winch and adapted to withstand the axial load. However, this negatively affects the operating space to be provided around the winch.

### SUMMARY

The object of the present disclosure is that of providing a cable collecting winch which combines features of simple construction and reduced overall dimension with the capacity to withstand by itself high axial loads.

The disclosure refers therefore to a cable collecting winch according to claim 1. Preferred characteristics of such cable collecting winch are indicated in the dependent claims.

In particular, the disclosure refers to a cable collecting winch, comprising:
a collecting drum rotatably actuatable about a respective longitudinal axis for winding/unwinding a cable, and
a cable guide device kinetically connected with the collecting drum and adapted to translate along a direction parallel to said longitudinal axis upon rotation of the collecting drum to guide the winding/unwinding of said cable, characterised in that the collecting drum and the cable guide device form a nut and screw assembly wherein the collecting drum and the cable guide device are respectively the screw and the nut of said nut and screw assembly.

Due to the aforementioned features, it is possible to provide a cable collecting winch that is structurally simple, has a reduced overall dimension and, at the same time, is capable of withstand high axial loads.

Firstly, in fact, the direct kinematic coupling between the collecting drum and the cable guide device provided in the form of a nut and screw assembly advantageously allows having a reduced number of components—in particular, moveable components—and a reduced overall dimension. Secondly, due to the fact that the cable guide device completely winds the collecting drum and it is engaged therewith substantially through a threaded coupling, the winch of the disclosure is capable of directly withstand high axial loads. Therefore, with the winch of the disclosure it is advantageously possible to obtain a configuration where the cable released by the winch is diverted in a direction parallel to the longitudinal axis of the collecting drum, without the need of further diverter elements outside the winch.

Furthermore, it should be observed that the particularly linear and compact construction of the winch of the disclosure causes fewer constraints to the design of external structure thereof, which, if necessary, can be selected in such a manner to confer a particular and desired aesthetic aspect to the winch. This feature is particularly advantageous when the winch is to be installed in an environment with high aesthetic value, such as for example, the deck of a large sailboat.

Preferably, the collecting drum is provided with a groove helically extended on the outer surface thereof, adapted to define a threading of the screw of the nut and screw assembly, and such groove has a width adapted to receive said cable.

This advantageously makes maintaining a uniform distribution of the cable on the collecting drum upon rotation thereof easier.

In a preferred embodiment of the disclosure, the winch comprises recirculating rolling elements operatively interposed between the collecting drum and the cable guide device.

Advantageously, a coupling with interposition of recirculating rolling elements can withstand higher loads compared to a threaded coupling and, due to the reduced friction between screw and nut, it has a better transmission efficiency.

The grove on the external surface of the collecting drum defines, in a direction parallel to the longitudinal direction of the collecting drum, a plurality of throats and, in the aforementioned preferred embodiment of the disclosure, each throat preferably receives two rolling elements.

Advantageously, this solution allows providing winches with small radial dimensions even when the width of the groove on the external surface of the collecting drum is required to be large for receiving cables having a large diameter. Additionally, the higher number of recirculating rolling elements improves the resistance to load.

The rolling elements are preferably balls.

The rolling elements are preferably made of plastic material. The choice of this material can be particularly advantageous when the winch is used in the nautical field, to avoid the adverse effects of salt corrosion.

Preferably, the winch of the disclosure comprises a guide rail for the cable guide device. Such guide rail advantageously defines an anti-rotation constraint for the cable guide device.

Preferably, the cable guide device comprises at least one diverter pulley.

Preferably, at least one of said collecting drum and said cable guide device is made of a light metal alloy, for example an aluminium alloy. Alternatively, at least one of such components can be made of a composite material.

### BRIEF DESCRIPTION OF THE DRAWINGS

Further characteristics and advantages of the present disclosure shall become clearer from the following detailed description of a preferred embodiment thereof, made hereafter, for indicating and not limiting purposes, with reference to the attached drawings. In such drawings:

FIG. 1 is a schematic perspective view, with parts partially removed, of a preferred embodiment of a cable collecting winch according to the disclosure, and

FIG. 2 is a schematic view, in longitudinal section, of a detail of the cable collecting winch of FIG. 1.

### DETAILED DESCRIPTION

In such figures a cable collecting winch according to the disclosure is globally indicated at reference numeral 1.

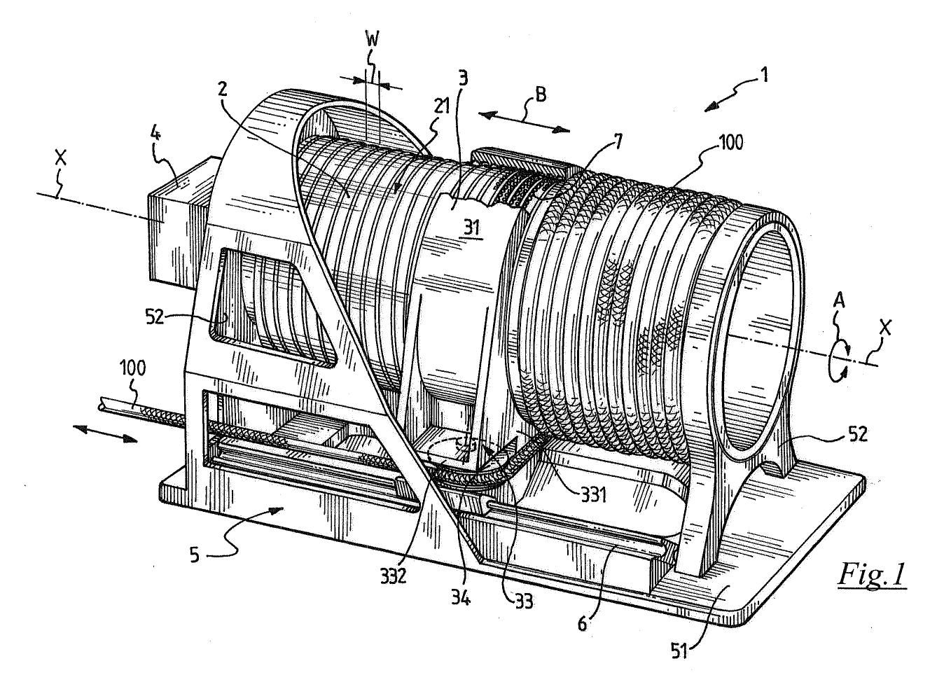

As shown in FIG. 1, the winch 1 essentially comprises a collecting drum 2, which can be rotatably actuated through motor means 4 about its longitudinal axis X-X to wind/unwind a cable 100, and a cable guide device 3 adapted to guide the winding/unwinding of the cable 100 on the collecting drum 2.

The collecting drum 2 and the cable guide device 3 are preferably mounted on a framework 5 essentially comprising a base 51 and supports 52 for the collecting drum 2. The base 51 can be suitably configured according to mounting requirements of the winch 1. The supports 52 are adapted to rotatably support the collecting drum 2 at opposite longitudinal ends thereof in such a manner that its longitudinal axis X-X substantially lies parallel to the base 51.

In the preferred embodiment illustrated herein the motor means 4, typically electrical or hydraulic and in any case of known type, are arranged at a longitudinal end of the collecting drum 2, while the opposite longitudinal end is entirely free on the respective support 52.

The collecting drum 2 and the cable guide device 3 are kinematically connected with each other in such a manner that each complete rotation of the collecting drum 2 (double arrow A in FIG. 1) determines a movement of the cable guide device 3 (double arrow B in FIG. 1) along a direction parallel to the longitudinal axis X-X of the collecting drum 2 over a section of predetermined length, typically equal to the diameter of the cable 100.

In particular, according to the disclosure, the collecting drum 2 and the cable guide device 3 are coupled with each other in such a manner to form a nut and screw assembly wherein the collecting drum 2 is the screw and the cable guide device 3 is the nut.

The collecting drum 2 is thus provided, at its outer surface, with a helical groove 21 defining a threading of the screw of the abovementioned nut and screw assembly. The groove 21 has a width W selected in such a manner to allow the cable 100 to be received therein and it is preferably equal to the cable diameter. The groove 21 therefore simultaneously serves as a threading for the screw and as an accommodation seat for the coils of the cable 100 on the collecting drum 2.

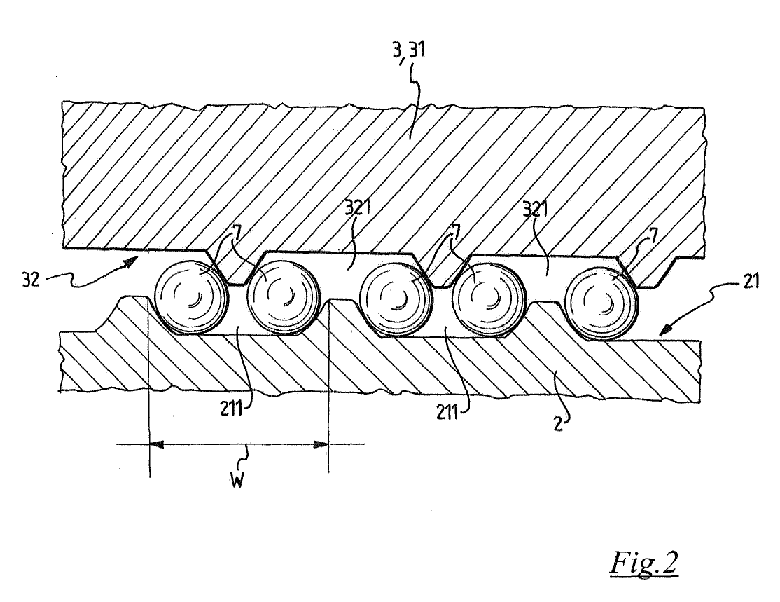

The cable guide device 3 essentially comprises an annular body 31 surrounding the collecting drum 2. At a radially inner side of the annular body 31 a helical groove 32 corresponding to the groove 21 or the collecting drum 2 is provided, defining a threading of the nut of the abovementioned nut and screw assembly (see FIG. 2). A guide portion 33, adapted to guide the cable 100 released by the collecting drum 2, is formed at a radially outer side of the annular body 31. The guide portion 33 is preferably formed with at least one first face 331 substantially perpendicular to the longitudinal axis X-X and a second face 332 substantially parallel to the longitudinal axis X-X, to enable the diversion of the cable 100 released by the collecting drum 2 in a direction parallel to the longitudinal axis X-X, as shown in FIG. 1. A diverter pulley 34 for the cable 100 is preferably arranged at the corner between the faces 331 and 332.

The cable guide device 3 preferably slidingly engages a guide rail 6 provided in the winch 1 parallel to the longitudinal axis X-X of the collecting drum 2. The guide rail 6 mainly serves as an anti-rotation constraint for the cable guide device 3 and it is not subjected to axial loads during the operation of the winch 1, being these loads totally transferred to the collecting drum 2 through the nut and screw coupling.

In the preferred embodiment of the disclosure herein shown, recirculating rolling elements 7, preferably balls are operatively interposed between the collecting drum 2 and the cable guide device 3. In order to reduce the radial dimensions of the nut and screw assembly a double recirculation is preferably used and, therefore, two rolling elements 7 are accommodated in each throat 211 of the groove 21 on the collecting drum 2 and in each throat 321 of the groove 32 on the cable guide device 3 (see FIG. 2). The grooves 21 and 31 are suitably offset with respect to each other in the direction of the longitudinal axis X-X to define two separate recirculation tracks in each throat 211 and 321.

The materials for the components described above can be selected according to the use the winch 1 is intended for. For nautical use, for example, light materials resistant to salt corrosion are preferred. In particular, in this case, the collecting drum 2 and/or the cable guide device 3 are preferably made of light metal alloys, such as for example aluminium alloys surface treated against salt corrosion. Alternatively, one or both of such components can be made of a composite material, for example containing carbon fibres. The rolling elements 7 in this case are preferably made of plastic material.

The way of operation of the winch 1 clearly results from the structural characteristics described above. The collecting drum 2 and the cable guide device 3 define a nut and screw assembly wherein driving the collecting drum 2 in rotation through motor means 4 determines the recovery or release of the cable 100 and, simultaneously, the translation of the cable guide device 3 to guide the winding/unwinding of the cable 100 on the collecting drum 2. Such assembly is by itself capable of withstanding high loads even in axial direction, therefore it is possible to provide for an actuation of the cable 100 with diversion parallel to the longitudinal axis X-X, as shown in FIG. 1, without the need of providing suitable diverter elements external to the winch.

Due to the structural and functional characteristics described above, the winch 1 finds a preferred, although not exclusive, use for actuating sheets on large sailboats.

1. A cable collecting winch comprising:
a collecting drum rotatably actuatable about a respective longitudinal axis (X-X) to wind/unwind a cable, and,
a cable guide device kinematically connected to said collecting drum and adapted to translate along a direction parallel to said longitudinal axis upon rotation of the collecting drum to guide the winding/unwinding of said cable, characterised in that said collecting drum and said cable guide device form a nut and screw assembly wherein the collecting drum and the cable guide device are respectively the screw and the nut of the nut and screw assembly.

2. The winch of claim 1, wherein said collecting drum is provided with a groove helically extended on a outer surface thereof, adapted to define a threading of the screw of said nut and screw assembly, and said groove has a width adapted to receive said cable.

3. The winch of claim 1, further comprising recirculating rolling elements operatively interposed between said collecting drum and said cable guide device.

4. The winch of claim 3, wherein said collecting drum is provided with a groove helically extended on a outer surface thereof, adapted to define a threading of the screw of said nut and screw assembly, and said groove has a width adapted to receive said cable, and said groove defines, in a direction parallel to said longitudinal axis, a plurality of throats each receiving two rolling elements.

5. The winch of claim 3, wherein said rolling elements are balls.

6. The winch of claim 3, wherein said rolling elements are made of plastic material.

7. The winch of claim 1, further comprising a guide rail for said cable guide device.

8. The winch of claim 1, wherein said cable guide device comprises at least one diverter pulley.

9. The winch of claim 1, wherein at least one of said collecting drum and said cable guide device is made of a light metal alloy.

10. The winch of claim 1, wherein at least one of said collecting drum and said cable guide device is made of a composite material.
